(19) United States
(12) Patent Application Publication
(10) Pub. No.: US 2026/0243983 A1
(43) Pub. Date: Aug. 20, 2026

(54) SYSTEM FOR DETERMINING OPTICAL PROBE LOCATION RELATIVE TO A PHOTONIC INTEGRATED CIRCUIT

(71) Applicant: Keysight Technologies, Inc., Santa Rosa, CA (US)

(72) Inventors: Christopher Coleman, Santa Clara, CA (US); Ryan Scott, Woodland, CA (US)

(21) Appl. No.: 19/645,950

(22) Filed: Apr. 13, 2026

Related U.S. Application Data
(63) Continuation of application No. 18/899,013, filed on Sep. 27, 2024.
Application No. 18/899,013 is a continuation-in-part of application No. 17/538,573, filed on Nov. 30, 2021, now Pat. No. 12,203,739.
(60) Provisional application No. 63/162,142, filed on Mar. 17, 2021.

(51) Int. Cl. G02B 6/42

(52) U.S. Cl. CPC G02B 6/4286; G02B 6/4215; G02B 6/4222; G02B 6/4226

(57) ABSTRACT

A photonic integrated circuit (PIC) is disclosed, and includes a substrate, and a diffractive optical element (DOE), which is adapted to receive an input optical signal. The DOE is disposed over the substrate and includes surface relief patterns that define a reflective, diffractive focusing lens apertured to retroreflect and focus light back over a prescribed incidence angular range to a DOE-defined focal point located at a reference position above a surface of the PIC. The DOE reflects light of the input optical signal such that reflected optical irradiance is at a maximum when the input optical signal is incident from the reference position.

### CROSS-REFERENCE TO RELATED APPLICATION

The present application is a continuation-in-part (CIP) application and claims priority under 35 U.S.C. § 120 from U.S. Patent Application No. 18/899,013, filed on September 27, 2024, which is a continuation-in-part application claiming priority from U.S. Patent 12,203,739, filed on November 30, 2021. The present application also claims priority under 35 U.S.C. § 119(e) and under 37 C.F.R. § 1.78(a) to commonly owned U.S. Provisional Application No. 63/162,142 filed on March 17, 2021. The entire disclosures of from U.S. Patent Application U.S. Patent Application No. 18/899,013, U.S. Patent 12,203,739 and U.S. Provisional Application No. 63/162,142 are specifically incorporated herein by reference in its entirety.

### BACKGROUND

Photonic Integrated Circuits (PICs) are ubiquitous in many aspects of communications, including optical fiber communications, as well as in other technical fields. The PICs may include various optical elements to include active optoelectronic devices, optical interferometers, splitting optical elements and filtering optical elements, to name a few. These various optical elements are selectively connected to one another, and to optical components connected to the PIC by optical waveguides of one of a variety of optical waveguides disposed in the PIC.

As will be appreciated, during the fabrication of the PIC and devices that include the PIC, testing of the function of the various optical elements of the PIC is useful This testing is beneficially non-contact testing to avoid damaging either the PIC or the optical probe during the testing. As such, the positioning of the probe must be controlled. Current optical probe position controls concentrate primarily on sensing probe height using capacitive proximity sensors and optical displacement sensors, such as interferometers and confocal chromatic sensors.

Unfortunately, known optical probe position control methods have certain disadvantages that can be problematic in applications. For example, the sensors that are currently used in optical probe position controls can be large compared to the size of the optical probe and must be remoted from the probing location. Moreover, known techniques provide only a single height measurement for an array of probes which may need multiple control points. Furthermore, known techniques use ‘displacement’ sensors, which do not measure distances, and thereby these known techniques are limited to tracking relative offsets

What is needed, therefore, is a system and method for controlling the height of an optical probe that overcomes at the drawbacks of the known systems and methods described above.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1A shows a simplified schematic block diagram of a system for determining optical probe location relative to a PIC in accordance with a representative embodiment.

FIG. 1B shows a simplified schematic block diagram of another system for determining optical probe location relative to a PIC in accordance with a representative embodiment.

FIG. 2A shows a portion of a PIC comprising a diffractive optical element (DOE) in accordance with a representative embodiment.

FIGS. 2B-2C show perspective views of diffractive optical elements (DOE’s) with the silicon slab and with the silicon slab removed, respectively, and in accordance with representative embodiments.

FIG. 2D shows a perspective view of a DOE comprising a single lens element in accordance with a representative embodiment.

FIGS. 2E-2F show perspective views of DOE’s comprising a plurality of lens elements in accordance with representative embodiments.

FIGS. 3A shows a sequence of a method useful in determining an absolute maximum reflection point at a particular angle in accordance with a representative embodiment.

FIGS. 3B shows a sequence of a method useful in determining the absolute maximum reflection point of FIG. 3A at another particular angle in accordance with a representative embodiment.

FIG. 4 shows a flow-chart of a method of determining optical probe location relative to PIC in accordance with a representative embodiment.

### DETAILED DESCRIPTION

In the following detailed description, for purposes of explanation and not limitation, representative embodiments disclosing specific details are set forth in order to provide a thorough understanding of an embodiment according to the present teachings. Descriptions of known systems, devices, materials, methods of operation and methods of manufacture may be omitted so as to avoid obscuring the description of the representative embodiments. Nonetheless, systems, devices, materials and methods that are within the purview of one of ordinary skill in the art are within the scope of the present teachings and may be used in accordance with the representative embodiments. It is to be understood that the terminology used herein is for purposes of describing particular embodiments only and is not intended to be limiting. The defined terms are in addition to the technical and scientific meanings of the defined terms as commonly understood and accepted in the technical field of the present teachings.

It will be understood that, although the terms first, second, third etc. may be used herein to describe various elements or components, these elements or components should not be limited by these terms. These terms are only used to distinguish one element or component from another element or component. Thus, a first element or component discussed below could be termed a second element or component without departing from the teachings of the present disclosure.

The terminology used herein is for purposes of describing particular embodiments only and is not intended to be limiting. As used in the specification and appended claims, the singular forms of terms ‘a’, ‘an’ and ‘the’ are intended to include both singular and plural forms, unless the context clearly dictates otherwise. Additionally, the terms "comprises", and/or "comprising," and/or similar terms when used in this specification, specify the presence of stated features, elements, and/or components, but do not preclude the presence or addition of one or more other features, elements, components, and/or groups thereof. As used herein, the term "and/or" includes any and all combinations of one or more of the associated listed items.

Unless otherwise noted, when an element or component is said to be “connected to”, or “coupled to” another element or component, it will be understood that the element or component can be directly connected or coupled to the other element or component, or intervening elements or components may be present. That is, these and similar terms encompass cases where one or more intermediate elements or components may be employed to connect two elements or components. However, when an element or component is said to be “directly connected” to another element or component, this encompasses only cases where the two elements or components are connected to each other without any intermediate or intervening elements or components.

This present teachings relate generally to the probing of photonic integrated circuits (PICs). PICs require both electrical and optical probes to interface with the signal I/O on the wafer (or die). Electrical probing is mature and well established, while optical probing is a relatively new concern. By the present teachings a system for non-contact intimate proximity optical probing is disclosed. As will become clearer as the present description continues, control of an optical waveguide probe position provides optimal results and good repeatability.

As described herein in connection with various representative embodiments, a system for determining optical probe location relative to a photonic integrated circuit (PIC) comprises: a diffractive optical element (DOE) disposed in the PIC, the DOE having a focal point of maximum reflection at location having coordinates in three-dimensions above the PIC; an optical waveguide probe; an optical source adapted to provide light through the optical waveguide probe and incident on the DOE, wherein the DOE reflects and focuses light back to the optical waveguide probe; a power meter adapted to receive at least a portion of the light reflected and focused at the focal point above the PIC; a motorized positioner adapted to move in optical waveguide probe in the three-dimensions above the PIC; a controller comprising a processor and a non-transitory computer-readable medium that stores instructions, which when executed by the processor, causes the processor to: control the motorized positioner to: move the optical waveguide probe in a first plane to locate a first maximum reflection in the first plane; move the optical waveguide probe to a second plane, and move the optical waveguide probe in the second plane to locate a second maximum reflection in the second plane; estimate a beam angle based on the first and second reflection maxima; and move the optical waveguide probe along a line between the first maximum reflection and the second maximum reflection to locate an absolute maximum reflection in a third plane. Notably, the location of the absolute maximum reflection is a reference point in three dimensions.

As described herein in connection with other various representative embodiments, a non-transitory computer readable medium adapted to store instructions, which when executed by a processor, cause the processor to: control a motorized positioner to: move an optical waveguide probe in a first plane to locate a first maximum reflection in the first plane; move the optical waveguide probe to a second plane, and move the optical waveguide probe in the second plane to locate a second maximum reflection in the second plane; estimate a beam angle based on the first and second reflection maxima; and move the optical waveguide probe along a line between the first maximum reflection and the second maximum reflection to locate the absolute maximum reflection in a third plane. The location of the absolute maximum reflection is a reference point in three dimensions.

As described herein in connection with other various representative embodiments, a method of determining location of an optical waveguide probe relative to a photonic integrated circuit (PIC) comprising a diffractive optical element (DOE) disposed in the PIC, the DOE having a focal point of maximum reflection at location having coordinates in three-dimensions above the PIC is disclosed. The method comprises: moving the optical waveguide probe in a first plane to locate a first maximum reflection in the first plane; moving the optical waveguide probe to a second plane, and moving the optical waveguide probe in the second plane to locate a second maximum reflection in the second plane; estimating a beam angle based on the first and second reflection maxima; and moving the optical waveguide probe along a line between the first maximum reflection and the second maximum reflection to locate the absolute maximum reflection in a third plane. The location of the absolute maximum reflection is a reference point in three dimensions.

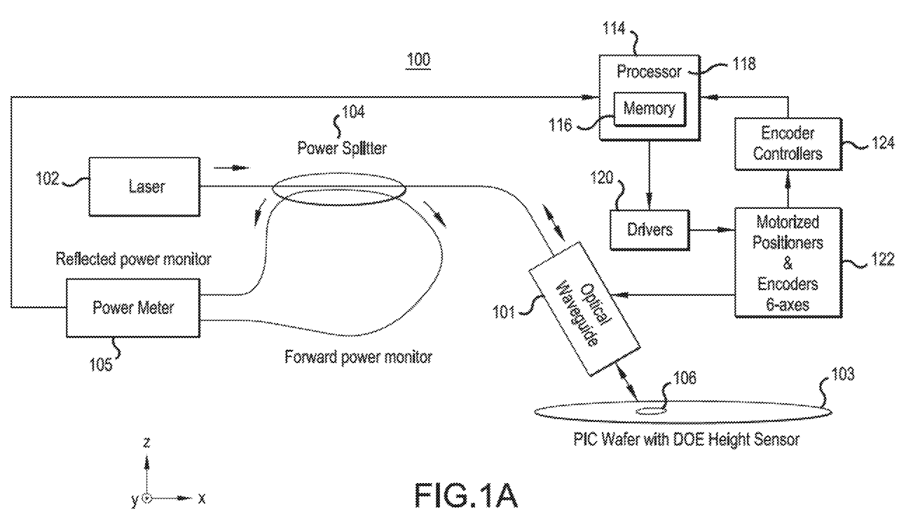

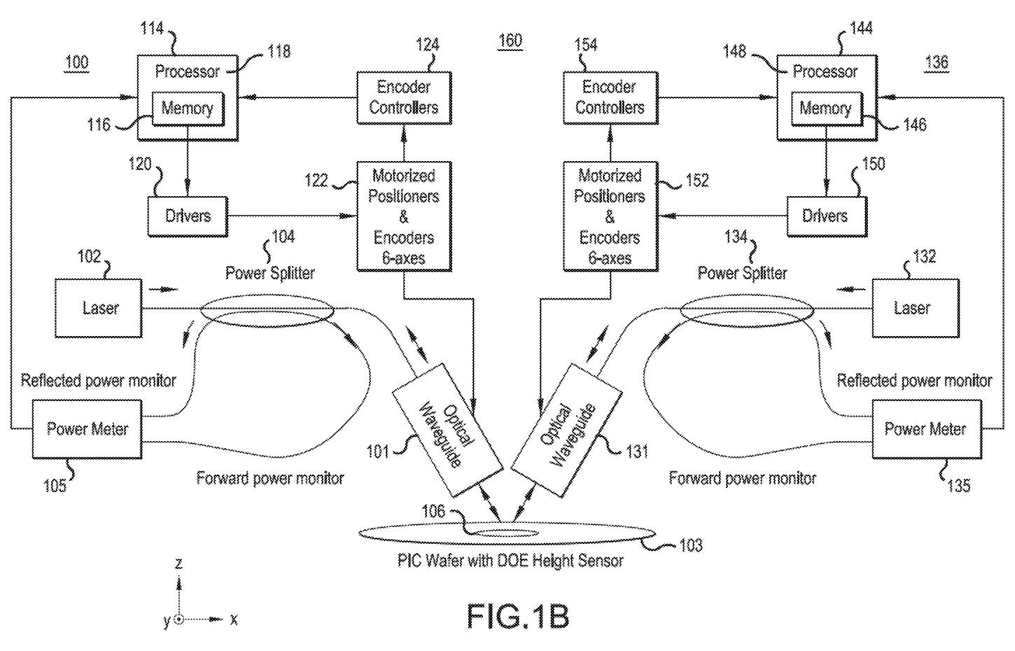

FIG. 1A shows a simplified schematic block diagram of a system 100 for determining a location of an optical waveguide probe 101 relative to a PIC 103 in accordance with a representative embodiment.

The system 100 comprises a laser that is coupled to an optical waveguide (e.g., an optical fiber) as shown. Output from the laser 102 is provided to a power splitter 104, which may be one of a number of known types of passive optical waveguide splitters. As indicated by the arrows in FIG. 1A, a portion of the emitted power of the laser 102 is provided to the optical waveguide probe 101, while another portion of the emitted power of the laser 102 is provided to a power meter 105. Notably, the power meter 105 is adapted to measure the power from signals from each of the input optical fibers thereto. This may be realized by providing a plurality of power meters within the power meter 105, or by providing a multiple channel power meter with the power meter 105. Illustratively, the power splitter 104 has a split ratio of 50:50, 70:30, or 90:10. The transmitted light that is measured by the power meter 105 is useful for taking a referenced measurement, which is discussed below. The ratio of reflected to transmitted light gives a more accurate result because it corrects for variations in the laser output power. As described more fully below, readings from the power meter 105 are used to determine a location of an absolute maximum reflected power from the DOE 106 of the PIC 103.

The portion of the light transmitted to the optical waveguide probe 101 from the power splitter 104 is incident on a diffractive optical element (DOE) 106 disposed at a surface of the PIC 103. The DOE 106 reflects light that is incident thereon back to the optical waveguide probe 101, and is provided to the power meter 105 through the power splitter 104. As described more fully below, the DOE 106 may comprise a plurality of lens elements that enable measurements via multiple wavelengths of light from the selected light source (e.g., laser 102); different angles of incidence (measured from the normal (z-direction of the coordinate system of FIG. 1A) of the optical waveguide probe 101; and different orientations of the optical waveguide (as discussed below in connection with FIG. 1B). Regardless of whether the DOE 106 comprises lens elements adapted for wavelength, angle of incidence or orientation, and the number of lens elements implemented in the DOE 106, only a single DOE is required. Beneficially, therefore, the area (“real estate”) of the PIC 103 is the same, and only one DOE 106 is required, saving valuable real estate on the PIC 103.

The power readings of the reflected power are provided to a controller 114, and as described more fully below, are used by the controller to adjust a height (z-direction in the coordinate system of FIG. 1A) of the optical waveguide probe 101 to be located at the point of the absolute maximum reflected power from the DOE 106 of the PIC 103. As will be appreciated by one of ordinary skill in the art, the location of the maximum reflected power from the DOE 106 of the PIC 103 is the focal point of the DOE, and is fixed in three-dimensions.

The controller 114 is coupled to a memory 116 and includes processor 118. The controller 114 is adapted to support a processor 118, which is tangible and non-transitory, is representative of one or more processors. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The processor 118 (and other processors) of the present teachings is an article of manufacture and/or a machine component. The processor 118 for the controller 114 is configured to execute software instructions stored in the memory 116 to perform functions as described in the various embodiments herein. The processor 118 may be a general-purpose processor or may be part of an application specific integrated circuit (ASIC). The processor 118 may also be (or include) a microprocessor, a microcomputer, a processor chip, a controller, a microcontroller, a digital signal processor (DSP), a state machine, or a programmable logic device. The processor 118 may also be (or include) a logical circuit, including a programmable gate array (PGA) such as a FPGA, or another type of circuit that includes discrete gate and/or transistor logic. The processor 118 may be (or include) a central processing unit (CPU), a graphics processing unit (GPU), or both. Additionally, the processor 118 may comprise multiple processors, parallel processors, or both. Multiple processors may be included in, or coupled to, a single device or multiple devices.

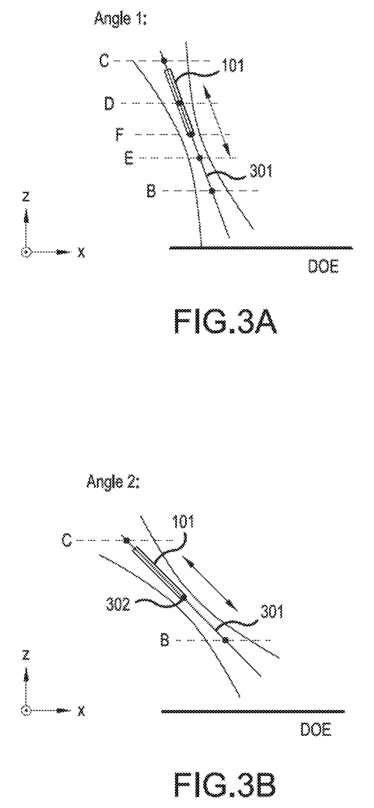

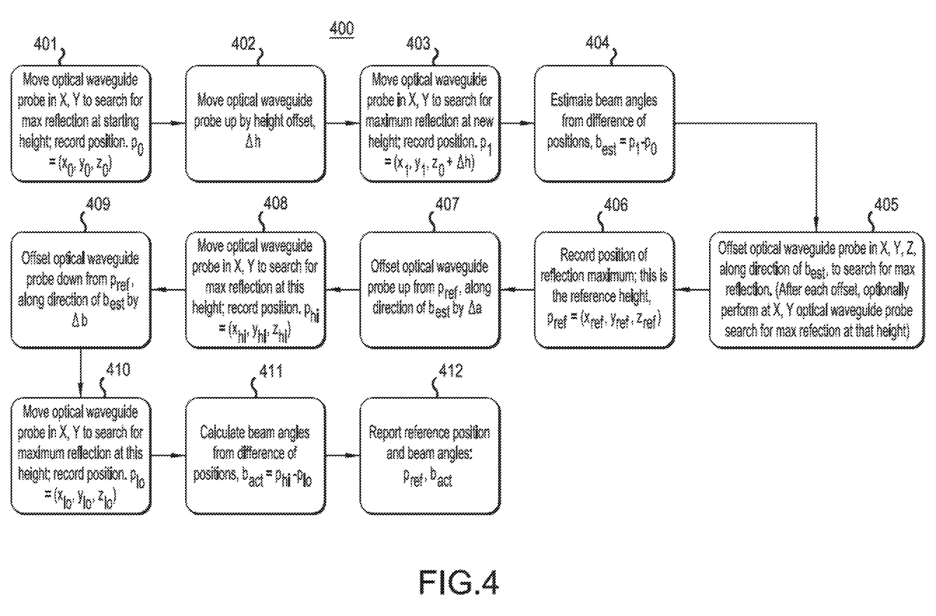

The memory 116 may comprise a main memory, a static memory, or both, where the memories may communicate with each other via a bus (not shown). The memory 116 described herein are tangible storage mediums that can store data and executable instructions, and are non-transitory during the time instructions are stored therein. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The memory 116 of the present teachings is an article of manufacture and/or machine component. The memory 116 includes one or more computer-readable mediums from which data and executable instructions (e.g., to carry out the processes described in connections with FIGS. 3A-4) can be read by a computer. Memories as described herein may be random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known to one of ordinary skill in the art. Memories of the present teachings may be volatile or non-volatile, secure and/or encrypted, unsecure and/or unencrypted. The controller 114, the memory 116 and the processor 118 may be housed within or linked to a workstation (not shown) such as a computer or another assembly of one or more computing devices, a display/monitor, and one or more input devices (e.g., a keyboard, joysticks and mouse) in the form of a standalone computing system, a desktop or a tablet, for example.

As described more fully below, the controller 114 issues control commands to drivers 120, which may also be referred to as motor controllers. The drivers 120 provide signals to motorized positioners 122, which illustratively include encoders to effect multi-axis (e.g., 6 axis) movement of the optical waveguide probe 101 in the locating of the maximum reflected power from the DOE 106. Illustratively, the drivers 120 are firmware and electronic circuits that translate motion instructions from the controller 114 into the physical signals needed to actuate the particular motor type of motorized positioners 122 in use.

The motorized positioners 122 are illustrative translation stage assemblies in hardware, and may include known motor technologies such as stepper motors, linear motors, piezoelectric motors, to name only a few. The encoders of the motorized positioners 122 are illustratively hardware mounted to the translations stages to monitor actual motion of the translation stages. The encoders can be one or more of known optical, magnetic or capacitive encoders.

Finally, the system 100 comprises encoder controllers 124 that comprise firmware and electronic circuits that translate the physical signals generated by the motion encoders into stage position. Notably, the encoder controllers 124 translate the physical signals output by the encoders into stage positions, and reports the stage positions back to the controller 114.

As described more fully below, in accordance with a representative embodiment, the system 100 enables the determination of the location of the absolute maximum reflected power from the DOE 106, and thereby in a non-contact manner enables the positioning of test probes used in the testing of PICs. In one representative embodiment, the controller 114 is adapted to command the motorized positioner 122 to: move the optical waveguide probe 101 in a first x-y plane (see FIG. 3A-3B) to locate a first maximum reflection in the first plane; move the optical waveguide probe 101 to a second x-y plane (see FIG. 3A-3B), and move the optical waveguide probe 101 in the second plane to locate a second maximum reflection in the second plane; and move the optical waveguide probe 101 to other planes until an absolute maximum reflection is located. These and other aspects of the present teachings are described more fully below in connection with FIGS. 3A-4.

As alluded to above, and as described more fully below, the DOE 106 comprises at least one lens element, but may comprise a plurality of lens elements. Regardless of the number of lens elements disposed in the PIC 103, only a single DOE is required, providing the noted benefits of the use of less real estate of the PIC 103.

The use of multiple lens elements enables significant latitude in carrying out measurements by providing specific lens elements based on the selected wavelength of light from the light source (e.g., laser 102), different angles of incidence of the optical waveguide probe 101, and, as described more fully below in connection with FIG. 1B, different orientations of the optical waveguide relative to the DOE/PIC. By providing the DOE 106 with a particular lens element for a particular wavelength of light, and/or a particular lens element for a particular angle of incidence, and/or a particular lens element for a particular orientation of the optical waveguide probe 101, greater latitude in carrying out the various measurements of the present teachings is provided. Notably, however, the method of measurement described below in FIGS. 3A-4 are the same. In particular, once a particular wavelength, angle of incidence or orientation of the optical waveguide probe 101is selected, the method of measurement is carried out according to the representative embodiments described below.

FIG. 1B shows a simplified schematic block diagram of a system 160 for determining a location of an optical waveguide probe 131 relative to the PIC 103 in accordance with a representative embodiment. Notably, the system 160 comprises system 100 (i.e., the first system 100) described above and a second system 136. The description of first system 100 is not repeated in the description of second system 136 to avoid obscuring the presently described representative embodiment.

As will be appreciated from the description of system 160, the second system 136 enables not only a system for conducting measurements with a second optical waveguide optical waveguide probe 131, but also enables the system 160 to provide a stimulus response pair. Specifically, in such an embodiment, one optical waveguide probe (e.g., optical waveguide probe 131 probe) launches light into the PIC 103 while an output probe (optical waveguide probe 131) collects light coming from another location on PIC 103 that originated from the input probe. Finally, and as will become clearer as the present description continues, the second system 136 is also adapted to carry out measurements at selected wavelengths, angles of incidence, and orientations, by providing a plurality of lens elements in the single DOE 106. Notably, and as will be appreciated by one of ordinary skill in the art, in an illustrative embodiment, the angle of incidence of the optical waveguide probe 101 can be assigned a positive value, and angle of incidence of the optical waveguide probe 131 can be assigned a negative value.

The second system 136 comprises a laser 132 that is coupled to an optical waveguide (e.g., an optical fiber) as shown. Output from the laser 132 is provided to a power splitter 134, which may be one of a number of known types of passive optical waveguide splitters. As indicated by the arrows in FIG. 1B, a portion of the emitted power of the laser 132 is provided to the optical waveguide probe 131, while another portion of the emitted power of the laser 132 is provided to a power meter 135. Notably, the power meter 135 is adapted to measure the power from signals from each of the input optical fibers thereto. This may be realized by providing a plurality of power meters within the power meter 135, or by providing a multiple channel power meter with the power meter 135. Illustratively, the power splitter 134 has a split ratio of 50:50, 70:30, or 90:10. The transmitted light that is measured by the power meter 135 is useful for taking a referenced measurement, which is discussed below. The ratio of reflected to transmitted light gives a more accurate result because it corrects for variations in the laser output power. As described more fully below, readings from the power meter 135 are used to determine a location of an absolute maximum reflected power from the DOE 106 of the PIC 103.

The portion of the light transmitted to the optical waveguide probe 131 from the power splitter 134 is incident on a diffractive optical element (DOE) 106 disposed at a surface of the PIC 103. The DOE 106 reflects light that is incident thereon back to the optical waveguide probe 131, and is provided to the power meter 135 through the power splitter 134. As described more fully below, the DOE 106 may comprise a plurality of lens elements that enable measurements via multiple wavelengths of light from the selected light source (e.g., laser 132); different angles of incidence (measured from the normal (z-direction of the coordinate system of FIG. 1B) of the optical waveguide probe 131; and different orientations of the optical waveguide (as discussed below in connection with FIG. 1B). Regardless of whether the DOE 106 comprises lens elements adapted for wavelength, angle of incidence or orientation, and the number of lens elements implemented in the DOE 106, only a single DOE is required. Beneficially, therefore, the area (“real estate”) of the PIC 103 is the same, and only one DOE 106 is required, saving valuable real estate on the PIC 103.

The power readings of the reflected power are provided to a controller 144, and as described more fully below, are used by the controller to adjust a height (z-direction in the coordinate system of FIG. 1B) of the optical waveguide probe 131 to be located at the point of the absolute maximum reflected power from the DOE 106 of the PIC 103. As will be appreciated by one of ordinary skill in the art, the location of the maximum reflected power from the DOE 106 of the PIC 103 is the focal point of the DOE, and is fixed in three-dimensions.

The controller 144 is coupled to a memory 146 and includes processor 148. The controller 144 is adapted to support a processor 148, which is tangible and non-transitory, is representative of one or more processors. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The processor 148 (and other processors) of the present teachings is an article of manufacture and/or a machine component. The processor 148 for the controller 144 is configured to execute software instructions stored in the memory 146 to perform functions as described in the various embodiments herein. The processor 148 may be a general-purpose processor or may be part of an application specific integrated circuit (ASIC). The processor 148 may also be (or include) a microprocessor, a microcomputer, a processor chip, a controller, a microcontroller, a digital signal processor (DSP), a state machine, or a programmable logic device. The processor 148 may also be (or include) a logical circuit, including a programmable gate array (PGA) such as a FPGA, or another type of circuit that includes discrete gate and/or transistor logic. The processor 148 may be (or include) a central processing unit (CPU), a graphics processing unit (GPU), or both. Additionally, the processor 148 may comprise multiple processors, parallel processors, or both. Multiple processors may be included in, or coupled to, a single device or multiple devices.

The memory 146 may comprise a main memory, a static memory, or both, where the memories may communicate with each other via a bus (not shown). The memory 146 described herein are tangible storage mediums that can store data and executable instructions, and are non-transitory during the time instructions are stored therein. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The memory 146 of the present teachings is an article of manufacture and/or machine component. The memory 146 includes one or more computer-readable mediums from which data and executable instructions (e.g., to carry out the processes described in connections with FIGS. 3A-4) can be read by a computer. Memories as described herein may be random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known to one of ordinary skill in the art. Memories of the present teachings may be volatile or non-volatile, secure and/or encrypted, unsecure and/or unencrypted. The controller 144, the memory 146 and the processor 148 may be housed within or linked to a workstation (not shown) such as a computer or another assembly of one or more computing devices, a display/monitor, and one or more input devices (e.g., a keyboard, joysticks and mouse) in the form of a standalone computing system, a desktop or a tablet, for example.

As described more fully below, the controller 144 issues control commands to drivers 150, which may also be referred to as motor controllers. The drivers 150 provide signals to motorized positioners 152, which illustratively include encoders to effect multi-axis (e.g., 6 axis) movement of the optical waveguide probe 131 in the locating of the maximum reflected power from the DOE 106. Illustratively, the drivers 150 are firmware and electronic circuits that translate motion instructions from the controller 144 into the physical signals needed to actuate the particular motor type of motorized positioners 152 in use.

The motorized positioners 152 are illustrative translation stage assemblies in hardware, and may include known motor technologies such as stepper motors, linear motors, piezoelectric motors, to name only a few. The encoders of the motorized positioners 152 are illustratively hardware mounted to the translations stages to monitor actual motion of the translation stages. The encoders can be one or more of known optical, magnetic or capacitive encoders.

Finally, the system 130 comprises encoder controllers 154 that comprise firmware and electronic circuits that translate the physical signals generated by the motion encoders into stage position. Notably, the encoder controllers 154 translate the physical signals output by the encoders into stage positions, and reports the stage positions back to the controller 144.

As described more fully below, in accordance with a representative embodiment, the second system 136 enables the determination of the location of the absolute maximum reflected power from the DOE 106, and thereby in a non-contact manner enables the positioning of test probes used in the testing of PICs. In one representative embodiment, the controller 144 is adapted to command the motorized positioner 152 to: move the optical waveguide probe 131 in a first plane (see FIG. 3A-3B) to locate a first maximum reflection in the first plane; move the optical waveguide probe 131 to a second plane (see FIG. 3A-3B), and move the optical waveguide probe 131 in the second plane to locate a second maximum reflection in the second plane; and move the optical waveguide probe 131 to other planes until an absolute maximum reflection is located. These and other aspects of the present teachings are described more fully below in connection with FIGS. 3A-4.

As alluded to above, and as described more fully below, the DOE 106 comprises at least one lens element, but may comprise a plurality of lens elements. Regardless of the number of lens elements disposed in the PIC

The use of multiple lens elements enables significant latitude in carrying out measurements by providing specific lens elements based on the selected wavelength of light from the light source (e.g., laser 132), different angles of incidence of the optical waveguide probe 131, and, as described more fully below in connection with FIG. 1B, different orientations of the optical waveguide relative to the DOE/PIC. By providing the DOE 106 with a particular lens element for a particular wavelength of light, and/or a particular lens element for a particular angle of incidence, and/or a particular lens element for a particular orientation of the optical waveguide probe 131, greater latitude in carrying out the various measurements of the present teachings is provided. Notably, however, the method of measurement described below in FIGS. 3A-4 are the same. In particular, once a particular wavelength, angle of incidence or orientation of the optical waveguide probe 131is selected, the method of measurement is carried out according to the representative embodiments described below.

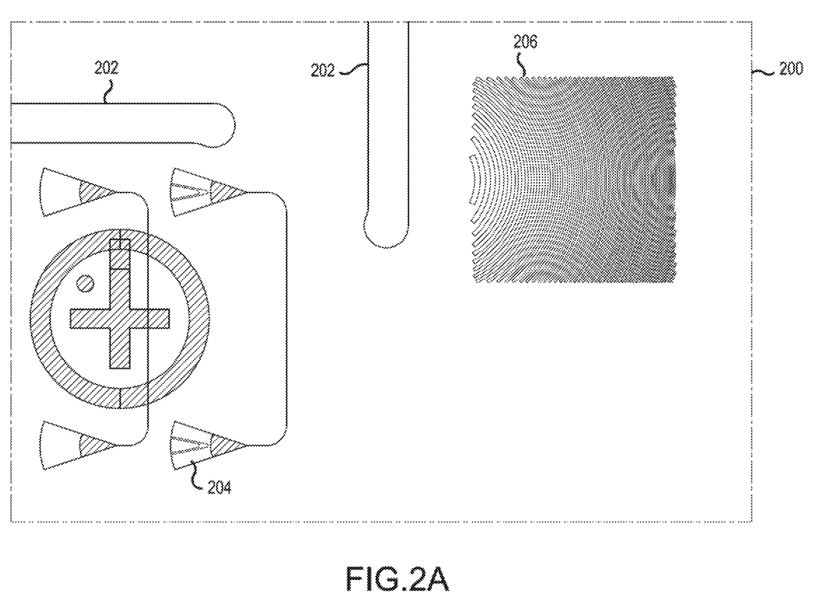

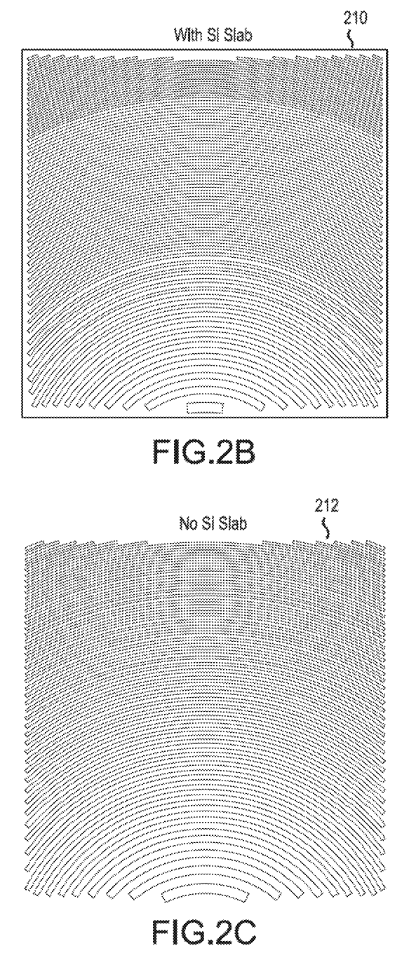

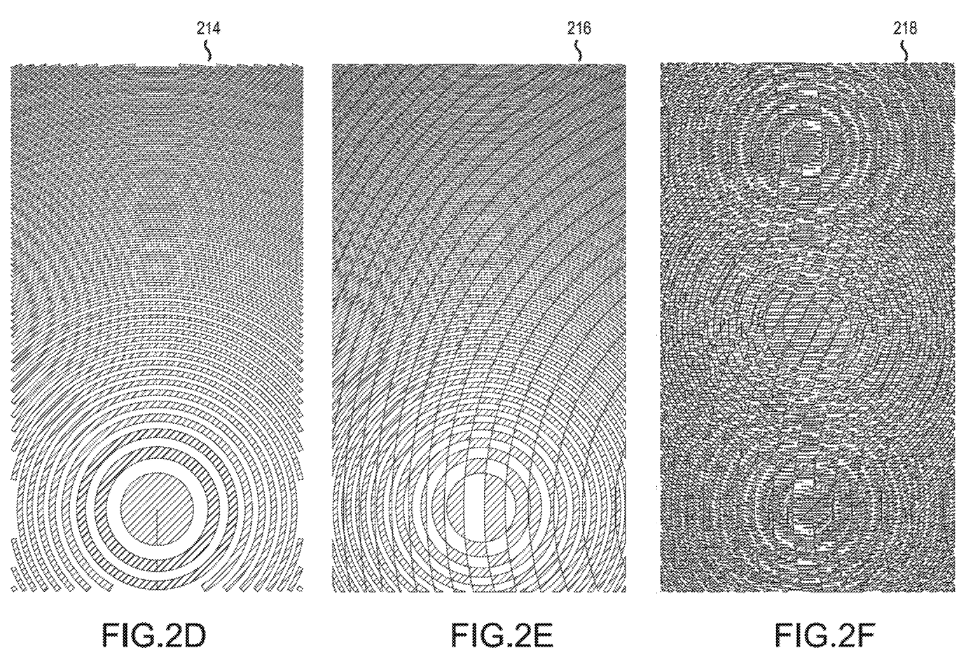

FIG. 2A shows a portion of a PIC 200 comprising a diffractive optical element (DOE) 206 in accordance with a representative embodiment. Notably, many aspects and details of the representative described in connection with FIG. 2A may be common to those described above in connection with FIGS. 1A-1B. These common aspects and details may not be repeated to avoid obscuring the description of the PIC 200 presently described.

The portion of PIC 200 may be a portion of the PIC 103 described previously. The PIC 200 comprises various optical waveguides 202 and passive and active optical elements 204 that are connected by the optical waveguides to effect one of a variety of functions such as optical communications.

The DOE 206 is provided at a location of the portion of the PIC 200 and is used to adjust the height of an optical waveguide probe (e.g., optical waveguide probe 101) to be located at a location of an absolute maximum reflection so that contactless testing of the PIC can be carried out.

FIGS. 2B-2C show top views of diffractive optical elements (DOE’s) contemplated for use as the DOE 206 disposed in the PIC in accordance with a representative embodiment. Notably, many aspects and details of the representative described in connection with FIGS. 1-2A may be common to those described above in connection with FIGS. 2A-2B. These common aspects and details may not be repeated to avoid obscuring the description of the DOEs presently described.

In accordance with a representative embodiment, DOEs 210, 212 are disposed over a silicon substrate (not shown) and comprise a layer of silicon (not shown) disposed between a lower layer of SiO₂ and an upper layer of SiO₂, which are not shown. Alternatively, the DOEs 210, 212 could comprise silicon nitride, indium phosphide, or lithium niobate, for example. The grooves shown are formed using a known etching process, and have a spacing designed to effect selective reflection of light (e.g., from the optical waveguide probe). Notably, DOEs 210, 212 are not linear diffraction gratings. To this end, and as is known to one of ordinary skill in the art, the curved arc of DOEs 210, 212 are designed to define the location in three dimensions where the absolute maximum reflection will occur.

Notably, the DOEs 210, 212 may be fabricated during front-side processing of the PIC in which they are disposed, and thereby are an integral part of the PIC, and are integrally formed during fabrication of the PIC. By way of illustration, the DOEs 210, 212 are free-space diffractive optical elements that can be designed into the semiconductor waveguiding layer of standard PIC fabrication processes. Specifically, using a known ‘slab waveguide’ fabrication process, binary surface relief, reflective diffractive elements can be realized, and in accordance with representative embodiments form a focusing lens for locating an optimal location (height) of the optical waveguide probe used in testing of the PIC. Fabrication of diffractive structures such as DOEs 210, 212 made in a wafer fabrication process of the PIC provide a very repeatable and accurate absolute reference. Only the pitch of the diffractive grooves determines the absolute position of the reference signals from the optical waveguide probe. The pitch control of optical lithography is very accurate and repeatable. Process errors in etch depth or groove width will only effect efficiency of the reflected power, but not their reference position (i.e., focal point). The relative maximization of power signals makes the use of the references independent of absolute efficiency.

Alternatively, the DOEs 210, 212 may be formed separately from the fabrication of the PIC, and attached to the surface of the PIC using a known adhesive bonding method.

Generally, the DOEs may include the silicon slab that is part of the waveguiding layer in which they are formed, or may have the silicon slab removed. Notably, DOE 210 includes the silicon slab and DOE 212 has the silicon slab removed.

The DOEs 210, 212, which are focusing lens, can be designed to retro-reflect and focus light from the optical waveguide probe (e.g., optical waveguide probe 101) back into itself at a specific (x,y,z) position (the focal point) in space. As alluded to above, and as described more fully below, when the optical waveguide probe is placed at this (x,y,z) position, the reflected power that returns back into the optical waveguide probe is at an absolute maximum. By the present teachings, a three-dimensional optimization search of reflected power is used to find the peak position. Once found, the fiber probe’s absolute (x,y,z) position is known relative to the PIC. This absolute reference position is then transferred to some other relative tracking sensor, such as position encoders on motorized translation stages (e.g., encoders of the motorized positioner 122 describe above). Offsets in height of the optical waveguide probe can be tracked to maintain knowledge of its absolute position. Notably, and as described more fully below, while the DOEs 210 (or diffractive focusing lens) are very sensitive to position, but insensitive to beam angle. This is a useful feature as the position reference will work for a wide range of different optical probe beam angles.

FIG. 2D show a top view of a diffractive optical element (DOE) 214 contemplated for use as the DOE’s 106, 206 disposed in the PIC in accordance with a representative embodiment. Notably, many aspects and details of the representative described in connection with FIGS. 1-2A may be common to those described above in connection with FIGS. 2A-2B. These common aspects and details may not be repeated to avoid obscuring the description of the DOEs presently described.

Notably, and as alluded to above, DOE 214 comprises a single lens element. This single lens element is contemplated for use as described herein with a selected wavelength of the light source (e.g., laser 102), a selected angle of incidence, and a selected orientation of the optical fiber waveguide probe (e.g., optical waveguide probe 131).

FIGS. 2E shows a top view of a diffractive optical element (DOE) 216 contemplated for use as the DOE’s 106, 206 disposed in the PIC in accordance with a representative embodiment. Notably, many aspects and details of the representative described in connection with FIG. 2D may be common to those described above in connection with FIGS. 2A-2C. These common aspects and details may not be repeated to avoid obscuring the description of the DOEs presently described.

A DOE 216 illustratively comprises two optical lens elements. Notably, the two optical lens elements are adapted to provide focal points based on one or more wavelength of the incident light, the angle of incidence, and the orientation of the optical waveguide probe. As can be seen from a review of FIG. 2E, there are two multiplexed patterns fabricated to provide two lens elements in the DOE 216. Notably, the multiplexing of the two (or more) patterns is illustratively carried out in the design or layout of the DOE 216. One of the patterns is substantially the same as the pattern as DOE 214 shown in connection with FIG. 2D. Additionally, a second pattern is multiplexed during design on top of the first pattern. As such, the DOE 216 comprises two lens elements, with each lens element having a particular focal point. Again, the lens elements may be adapted to provide a desired focal point based on the wavelength of incident light from the light source (e.g., laser 102), the angle of incidence of the incident light, or the orientation of the optical waveguide probe (e.g., optical waveguide probe 131). It is emphasized that the use of only two lens elements is merely illustrative, and additional lens elements (e.g., such as described in connection with FIG. 2F) are contemplated for inclusion on the DOE 216. Moreover, and of significance, each of the lens elements of the DOE’s of the present teachings comprising a plurality of elements may be fabricated for different ends. For example, one of the lens elements of the DOE 216 may be selected for a particular wavelength of light from the light element; whereas the other lens element may be selected for a particular angle or incidence or orientation of the optical waveguide probe. As will be appreciated, this flexibility enables flexibility in carrying out various measurements usings systems 100, 160 according to various representative embodiments.

FIGS. 2F shows a top view of a diffractive optical element (DOE) 218 contemplated for use as the DOE’s 106, 206 disposed in the PIC in accordance with a representative embodiment. Notably, many aspects and details of the representative described in connection with FIGS. 1-2B may be common to those described above in connection with FIGS. 2A-2C. These common aspects and details may not be repeated to avoid obscuring the description of the DOEs presently described.

A DOE 218 illustratively comprises four optical lens elements. Notably, the four optical lens elements are adapted to provide focal points based on one or more of wavelength of the incident light, the angle of incidence, and the orientation of the optical waveguide probe. As can be seen from a review of FIG. 2E, there are four multiplexed patterns fabricated to provide two lens elements in the DOE 218. One of the patterns is substantially the same as the pattern as DOE 214 shown in connection with FIG. 2C. Additionally, second, third and fourth patterns are multiplexed during design on top of the first pattern. As such, the DOE 218 comprises four lens elements, with each lens element having a particular focal point. Again, the lens elements may be adapted to provide a desired focal point based on the wavelength of incident light from the light source (e.g., laser 102), the angle of incidence of the incident light, or the orientation of the optical waveguide probe (e.g., optical waveguide probe 101). It is emphasized that the use of only four lens elements is merely illustrative, and additional lens elements are contemplated for inclusion on the single DOE 218. Moreover, and of significance, each of the lens elements of the DOE’s of the present teachings comprising a plurality of elements may be fabricated for different ends. For example, one of the lens elements of the DOE 218 may be selected for a particular wavelength of light from the light element; another lens element may be selected for a particular angle of incidence; the third may be selected for a particular orientation of the optical waveguide probe; and the fourth may be selected for another of the available options. As will be appreciated, this flexibility enables flexibility in carrying out various measurements usings systems 100, 160 according to various representative embodiments.

FIGS. 3A shows a method useful in determining an absolute maximum reflection point at a particular angle in accordance with a representative embodiment. Notably, many aspects and details of the representative described in connection with FIGS. 1-2C may be common to those described above in connection with FIG. 3A. These common aspects and details may not be repeated to avoid obscuring the description of the sequence used to determine the location of an absolute maximum reflection point presently described. Furthermore, the sequence described presently is similar to the method described in connection with FIG. 4. As alluded to above, the sequence of FIG. 3A is contemplated for use in connection with the system 100 of FIGS. 1A, 1B, and as described more fully below, is implemented as instructions stored in memories 116, 146 executed by the processors 118, 148 of the controllers 114, 144. Notably, for ease of description, FIGS. 3A-4 describe the function of the first system 100 in exacting measurements according to the present teachings. As will be appreciated, the function of the second system 136 is substantively the same in carrying out measurements as the first system 100. Therefore, the details of measurements using the second system 136 are not provided in connection with FIGS. 3A-4 to avoid obscuring the presently described representative embodiments.

Referring to FIG. 3A, the optical waveguide probe 101 is moved using the motorized positioner 122 based on control signals from the controller 114 to adjust its height (z-direction in the coordinate system of FIG. 3A) to a plane “B.” As noted above, the control signals from the controller 114 are determined are based on instructions stored in the memory 116, and are executed by a processor 118 to cause the processor 118 to move the motorized positioner 122 as described above in connection with FIG. 1A, and more fully below in connection with FIG. 4. Again, and based on instructions stored in memory 116, control signals from the controller 114 cause the optical waveguide probe 101 to be moved using the motorized positioner 122 within the plane B (i.e., in an x, y plane according to the coordinate system of FIG. 3A) to locate local maximum reflection in plane B (solid dot in plane B) based on the power returned to the power meter 105 of the system 100 by way of the optical waveguide probe 101 and the power splitter 104. This is recorded in memory 116 as the first maximum reflection.

After recording the power level of the first maximum, the optical waveguide probe 101 is moved using the motorized positioner 122 based on control signals from the controller 114 to adjust its height (z-direction in the coordinate system of FIG. 3A) to a plane “C.” Again, the control signals from the controller 114 are determined are based on instructions stored in the memory 116, and are executed by a processor 118 to cause the processor 118 to move the motorized positioner 122 as described above in connection with FIG. 1A, and more fully below in connection with FIG. 4. Based on instructions stored in memory 116, control signals from the controller 114 cause the optical waveguide probe 101 to be moved using the motorized positioner 122 within the plane C (i.e., in an x, y plane according to the coordinate system of FIG. 3A) to locate local maximum reflection in plane C based on the power returned to the power meter 105 of the system 100 by way of the optical waveguide probe 101 and the power splitter 104. This is recorded in memory 116 as the second maximum reflection.

This sequence is continued and the optical waveguide probe 101 along a line 301 between the first maximum reflection in plane B and the second maximum reflection in plane C to other planes (e.g., planes F, D, E) until an absolute maximum reflection is located. This location may be referred to herein as the reference position in three-dimensions. Notably, the line 301 is the center-line of the illumination and, as discussed more fully below, determines the beam pointing angles. Once the location of the maximum reflection is located, the height of the optical waveguide probe for further testing of the PIC is set, and fosters reliably reproducible testing of the PIC. Notably, one method used to determine the location of the absolute maximum reflection is described more fully in connection with a representative embodiment of FIG. 4 below.

Notably, and as described in connection with representative embodiments of FIG. 4, after the location of the absolute maximum reflection (the reference position) is determined, the sequence may be continued in other planes to refine the beam angle. For example, if after determining the location of the absolute maximum reflection is at the solid dot in plane F (the reference position), the sequence may be continued with the optical waveguide probe 101 being moved using the motorized positioner 122 based on control signals from the controller 114 to adjust its height (z-direction in the coordinate system of FIG. 3A) to a plane “D.” Again, the control signals from the controller 114 are determined are based on instructions stored in the memory 116, and are executed by a processor 118 to cause the processor 118 to move the motorized positioner 122 as described above in connection with FIG. 1A, and more fully below in connection with FIG. 4. Based on instructions stored in memory 116, control signals from the controller 114 cause the optical waveguide probe 101 to be moved using the motorized positioner 122 within the plane D (i.e., in an x, y plane according to the coordinate system of FIG. 3A) to locate local maximum reflection in plane D based on the power returned to the power meter 105 of the system 100 by way of the optical waveguide probe 101 and the power splitter 104. This is recorded in memory 116 as a location of a fourth maximum reflection. However, and notably, by moving the optical waveguide probe 101 in the plane D, it may be determined that the location of the fourth maximum reflection is off the line 301. This will allow adjustment of the determined beam angle and will increase the accuracy of the positioning of the optical waveguide probe at a proper height and beam angle.

Further accuracy in locating the beam angle may be attained by continuing the sequence with the optical waveguide probe 101 being moved using the motorized positioner 122 based on control signals from the controller 114 to adjust its height (z-direction in the coordinate system of FIG. 3A) to a plane “E.” Again, the control signals from the controller 114 are determined are based on instructions stored in the memory 116, and are executed by a processor 118 to cause the processor 118 to move the motorized positioner 122 as described above in connection with FIG. 1A, and more fully below in connection with FIG. 4. Based on instructions stored in memory 116, control signals from the controller 114 cause the optical waveguide probe 101 to be moved using the motorized positioner 122 within the plane E (i.e., in an x, y plane according to the coordinate system of FIG. 3A) to locate local maximum reflection in plane E based on the power returned to the power meter 105 of the system 100 by way of the optical waveguide probe 101 and the power splitter 104. This is recorded in memory 116 as a location of a fifth maximum reflection. However, and notably, by moving the optical waveguide probe 101 in the plane E, it may be determined that the location of the fifth maximum reflection is off the line 301. This will allow further adjustment of the determined beam angle and will increase the accuracy of the positioning of the optical waveguide probe at a proper height and beam angle.

FIG. 3B shows a method useful in determining the absolute maximum reflection point of FIG. 3A at another particular angle in accordance with a representative embodiment. Notably, many aspects and details of the representative described in connection with FIG. 3B may be common to those described above in connection with FIGS. 1A-3A. These common aspects and details may not be repeated to avoid obscuring the description sequence for determining the location of the absolute maximum reflection presently described. As alluded to above, the sequence of FIG. 3B is contemplated for use in connection with the system 100 of FIG. 1A, and as described more fully below, is implemented as instructions stored in memory 116 executed by the processor 118 of the controller 114.

For purposes of illustration, suppose point 302 along line 301 has been identified as the location of the absolute maximum reflection from the DOE. By moving the optical waveguide probe 101 using the motorized positioner 122 based on control signals from the controller 114 to adjust its height (z-direction in the coordinate system of FIG. 3B) to a plane “C.” Again, the control signals from the controller 114 are determined are based on instructions stored in the memory 116, and are executed by a processor 118 to cause the processor 118 to move the motorized positioner 122 as described above in connection with FIG. 1A, and more fully below in connection with FIG. 4. Based on instructions stored in memory 116, control signals from the controller 114 cause the optical waveguide probe 101 to be moved using the motorized positioner 122 within the plane C (i.e., in an x, y plane according to the coordinate system of FIG. 3A) to locate local maximum reflection (represented by the solid dot) in plane C based on the power returned to the power meter 105 of the system 100 by way of the optical waveguide probe 101 and the power splitter 104.

Similarly, moving the optical waveguide probe 101 using the motorized positioner 122 based on control signals from the controller 114 to adjust its height (z-direction in the coordinate system of FIG. 3B) to a plane “B.” Again, the control signals from the controller 114 are determined are based on instructions stored in the memory 116, and are executed by a processor 118 to cause the processor 118 to move the motorized positioner 122 as described above in connection with FIG. 1A, and more fully below in connection with FIG. 4. Based on instructions stored in memory 116, control signals from the controller 114 cause the optical waveguide probe 101 to be moved using the motorized positioner 122 within the plane B (i.e., in an x, y plane according to the coordinate system of FIG. 3B) to locate local maximum reflection (represented by the solid dot) in plane B based on the power returned to the power meter 105 of the system 100 by way of the optical waveguide probe 101 and the power splitter 104.

As will be appreciated, the location of the maximum reflected power from DOE reference (solid dot in plane F) determines the optimal location (in x, y, z) for the optical waveguide probe 101 for testing the PIC, but is insensitive to beam angle. So, assuming maximum reflected power from DOE reference (solid dot in plane F) is the same in FIGS. 3A and 3B, the beam angles are different. As such, the location of the maximum reflected power from the DOE is insensitive to the angle as a comparison of the angles of line 301 of FIG. 3A is with line 301 in FIG. 3B. As such, the location of the absolute maximum reflection (solid dot in plane “F”) is insensitive to an angle of the optical waveguide probe 101. However, the different beam angles of the probe can still be determined by calculating the vector that connects the maxima located in different planes, for example ‘D’ & ‘E’

FIG. 4 shows a flow-chart of a method 400 of determining optical probe location relative to PIC in accordance with a representative embodiment. Notably, many aspects and details of the representative described in connection with FIG. 4 may be common to those described above in connection with FIGS. 1A-3B, with particular reference to the details of the representative embodiments described in connection with FIGS. 3A-3B. These common aspects and details may not be repeated to avoid obscuring the description sequence for determining the location of the absolute maximum reflection presently described. Furthermore, as alluded to above, the method of FIG. 4 is contemplated for use in connection with the system 100 of FIG. 1A, and may be implemented as instructions stored in memory 116 executed by the processor 118 of the controller 114.

At 401, method 400 begins by moving the optical waveguide probe 101 in x, y (i.e., a plane such as plane B in FIGS. 3A-3B to search for a maximum reflection from the DOE 106 of the PIC 103 at a starting height (z dimension); and recording the location of the maximum reflection position at the starting height, pₒ = (xₒ,yₒ,zₒ), in memory 116.

At 402, optical waveguide probe 101 is moved up by height offset, Δh (in the z-direction).

At 403, the optical waveguide probe 101 is moved in the x,y plane (e.g., plane C is FIGS. 3A-3B) at the new height (z coordinate) to search for the location of a maximum reflection from the DOE 106 of the PIC 103 at the new height; and the location of the maximum reflection in this second planed is recorded in memory 116 at position, p₁ = (x₁,y₁,zₒ+ Δh)

At 404, the beam angles are estimated from a difference of positions, bₑₛₜ = p₁-p₀. By way of illustration, the beam angle of line 301 in FIG. 3A is determined by the processor 118 and stored in the memory 116.

At 405, optical waveguide probe 101 is translated or moved in three dimensions (x, y, z), along direction of bₑₛₜ, to search for a location of maximum reflection at the new coordinates. Notably, and as described above in connection with FIG. 3A, at each offset iteration, the optical waveguide probe 101 may be moved in the x, y plane at its new position to search for a maximum reflection from the DOE 106 at this new height.

At 406 the position of the absolute maximum reflection is recorded in memory 116, and provides a reference height p_{ref} = (x_{ref}, y_{ref}, z_{ref}), which is the solid dot in plane “F” in FIG. 3A.

At 407 the optical waveguide probe 101 is displaced from p_{ref}, along direction of bₑₛₜ by Δa, which is the height offset to plane “D.” This movement may be along line 301 of FIG. 3A, for example, along line 301 from plane “F” to plane “D.”

At 408 the optical waveguide probe 101 is moved in the x,y plane to search for maximum reflection from the DOE 106 at this height; this position pₕᵢ = (xₕᵢ,yₕᵢ,zₕᵢ) is recorded in memory 116.

At 409 the optical waveguide probe 101 is moved down from p_{ref}, along direction of bₑₛₜ by Δb. This movement may be along line 301 of FIG. 3A, for example, along line 301 from plane “F” to plane “E.”

At 410, the optical waveguide probe 101 is moved in the x,y plane to search for maximum reflection from the DOE 106 at this height; this position, pₗₒ = (xₗₒ,yₗₒ,zₗₒ) is recorded in memory 116.

At 411, based on the difference of the positions b_{act} = pₕᵢ-pₗₒ the processor 118 determines the beam angles and these angles are recorded in memory 116.

Finally, at 412, reference position p_{ref} and beam angle b_{act} are recorded in memory and are used to locate the optical waveguide probe 101 in three dimensions at a location of the absolute maximum reflected power and determine the pointing angles of the probe beam.

Although various components, systems and methods for determining optical probe location relative to a PIC comprising a diffractive optical element (DOE) disposed in the PIC have been described with reference to several representative embodiments, it is understood that the words that have been used are words of description and illustration, rather than words of limitation. Changes may be made within the purview of the appended claims, as presently stated and as amended, without departing from the scope and spirit of the present teachings.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “teachings” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The inventive concepts also encompass a computer readable medium that stores instructions that cause a data processing system (such as the DSP of an NVA) to execute the methods described herein. A computer readable medium is defined to be any medium that constitutes patentable subject matter under 35 U.S.C. §101 and excludes any medium that does not constitute patentable subject matter under 35 U.S.C. §101. Examples of such media include non-transitory media such as computer memory devices that store information in a format that is readable by a computer or data processing system. More specific examples of non-transitory media include computer disks and non-volatile memories.

Aspects of the present invention may be embodied as an apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The preceding description of the disclosed embodiments is provided to enable any person skilled in the art to practice the concepts described in the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

1. A photonic integrated circuit (PIC) comprising:
a substrate; and
a diffractive optical element (DOE) adapted to receive an input optical signal, the DOE being disposed over the substrate and comprising surface relief patterns that define a reflective, diffractive focusing lens apertured to retroreflect and focus light back over a prescribed incidence angular range to a DOE-defined focal point located at a reference position above a surface of the PIC, wherein the DOE reflects light of the input optical signal such that reflected optical irradiance is at a maximum when the input optical signal is incident from the reference position.

2. The PIC of claim 1, wherein the DOE is positioned proximately to optical waveguides or passive or active optical components to serve as a reference for a height of the reference position.

3. The PIC of claim 1, wherein surface relief patterns have a pitch that sets the reference position in three dimensions.

4. The PIC of claim 1, wherein occurrence of the maximum reflection indicates that the input optical signal is incident within the prescribed incidence angular range.

5. The PIC of claim 4, wherein the reference position corresponds to the DOE-defined focal point of the reflective, diffractive focusing lens above the PIC.

6. The PIC of claim 1, wherein the reference position is an absolute position that is transferred to a tracking sensor.

7. The PIC of claim 1, wherein the reference position is denoted P_{ref} and is represented by: P_{ref} = (x_{ref,} y_{ref,} z_{ref}), where z_{ref} is a reference height above a surface of the PIC and x_{ref} and y_{ref} define a lateral reference location relative to the DOE.

8. The PIC of claim 1, wherein the DOE is configured such that the reference position remains substantially fixed for different angles of incidence of the input optical signal within the prescribed incidence angular range.

9. The PIC of claim 1, wherein variations in angle of incidence within the prescribed incidence angular range produce lateral shifts in locations of local reflection maxima at different heights above the PIC while the reference position corresponding to the maximum reflection remains substantially fixed.

10. The PIC of claim 1, wherein variations in widths or etch depths of the surface relief patterns affect optical efficiency but not the location of the reference position.

11. The PIC of claim 1, wherein a beam angle vector (b_{act}) of the input optical signal is determinable based on a difference between a first position pₕᵢ corresponding to a reflection maximum at a first offset from P_{ref} and a second position pₗₒ corresponding to a reflection maximum at a second offset from Pref, according to: b_{act} = pₕᵢ– p_{lo,} wherein pₕᵢ= (x_{hi,} y_{hi,} z_{hi,}) and pₗₒ = (xₗₒ yₗₒ zₗₒ ).

12. The PIC of claim 11, wherein the first offset and the second offset are on opposite sides of P_{ref} along a best estimated beam direction.

13. The PIC of claim 11, wherein the best estimated beam direction is determinable from a difference between a first reflection-maximum position p₀ = (x₀ y₀ z₀) measured at a starting height and a second reflection-maximum position p₁ = (x₁ y₁ z₀ + Δh) measured at a height offset Δh, such that the best estimate beam direction equals p₁ − p₀.

14. The PIC of claim 1, wherein the aperture defines a bounded region through which incident light is received and retro-reflected, the aperture delimiting an effective numerical aperture of the diffractive focusing lens.

15. The PIC of claim 1, wherein the DOE comprises a plurality of focusing lenses multiplexed in a common footprint by superimposing two or more diffractive patterns.

16. The PIC of claim 15, wherein at least some of the focusing lenses are configured for different wavelengths of the input optical signal.

17. The PIC of claim 15, wherein at least some of the focusing lenses are configured for different angles of incidence of the input optical signal.

18. The PIC of claim 1, further comprising a plurality of diffractive optical elements (DOEs) disposed at different respective locations on the PIC, each of the plurality of DOEs comprising a surface relief pattern to provide a reflective diffractive focusing lens, and each DOE has a corresponding focal point above the PIC.

19. The PIC of claim 18, wherein each of the plurality of diffractive optical elements is configured such that the location of its respective focal point is substantially insensitive to variations in angle of incidence within the prescribed angular range.

20. The PIC of claim 18, wherein each of the plurality of DOEs is arranged as a two-dimensional array spatially aligned with multiple optical waveguide outputs or fiber-array outputs, each DOE of the array having a corresponding focal point for retro-reflection of light from a corresponding optical fiber or waveguide output.
